(19) United States
(12) Patent Application Publication
(10) Pub. No.: US 2008/0079908 A1
(43) Pub. Date: Apr. 3, 2008

(54) Visual advertising apparatus for gateway

(76) Inventor: Hae-Yong Choi, Seoul-city (KR)

Correspondence Address: BACON & THOMAS, PLLC, 625 SLATERS LANE, FOURTH FLOOR, ALEXANDRIA, VA, 22314, US

(21) Appl. No.: 11/540,521

(22) Filed: Oct. 2, 2006

(51) Int. Cl. G03B 21/14

(52) U.S. Cl. 353/79

(57) ABSTRACT

A visual advertising apparatus for a gateway is disclosed. The apparatus includes a screen which includes a reflecting surface having a reflectance of 5% to 40% and reflecting lines formed on the reflecting surface in either a vertical or horizontal direction, the reflecting lines having a reflectance of 0.5% to 20%, and a projector for projecting light to the screen. Accordingly, the brightness of the screen is increased by five to forty times, viewers can see the clear image while moving around within the extended vertical and horizontal viewing angles of 30° to 4.5°, and the weight of the screen and the projector can be reduced, which makes it possible to install the large screen.

### BACKGROUND OF THE INVENTION

1. Field of the Invention

The present invention relates to a visual advertising apparatus, and more particularly to a visual advertising apparatus for a gateway which can increase a brightness of the screen, enable viewers to see a clear image while moving around within extended vertical and horizontal viewing angle ranges, and be reduced in weight.

2. Description of the Related Art

In general, many shopping clients stand in line at checkout counters, e.g., in a shopping mall. So, it is very effective to install a screen for visual advertisement at a position where the shopping clients near the checkout counters can easily observe.

A gateway or a gate of a commercial place or the like has a relatively small width for allowing only one or two persons to pass through, and is commonly very bright.

When installing an advertising apparatus in a bright place like the gateway or the gate of the commercial place, as the size of the screen is larger and the image on the screen is clearer, the advertising effect becomes higher.

Typically, the brightness of the inside of the commercial place like the shopping mall is in the range of 1,000 Lux to 3,000 Lux.

In order to increase the advertising effect, the brightness of the screen of the advertising apparatus should be at least three times the brightness of the installing place. In other words, the brightness of the screen of the advertising apparatus should be 3,000 Lux to 9,000 Lux.

However, a PDP (Plasma Display Panel) having a size (a diagonal length) of 40 inch to 50 inch, which is widely used as the advertising apparatus, has the brightness of only 500 cd/m² to 1,000 cd/m².

Further, as the size of the PDP is larger, it becomes considerably more expensive. Also, because the PDP having the size of 60 inch or more is very heavy, it is difficult or impossible to install the PDP to the gateway or the gate where many people pass through.

When using a screen such as a white mat screen or a glass bead screen and a projector having the brightness of 3,000 ANSI as the advertising apparatus, the brightness of the screen becomes only 10 cd m² to 100cd/m², which is not adequate for the advertising apparatus. Further, as the size of the conventional screen is larger, the brightness becomes considerably lower.

Generally, the gate, the entrance or the escalator has a width of about 0.7 m to 1.5 m, and the moving width of the viewer who uses the gate, the entrance or the escalator is only within about 2 m. And, if considering that the viewers should stand in line when using the above facilities, it is preferable to increase a vertical viewing angle for increasing a maximum effective viewing distance.

In order to maximize the advertising effect in the aforesaid situation, it is preferable that the screen has a vertical viewing angle of 10° to 30° and a horizontal viewing angle of 4.5° to 20°.

Because the conventional screen diffuses the light to an unnecessary range (the vertical or horizontal diffusing angle is 180°), the brightness is further decreased.

In addition, as the viewing distance is longer, the image of the screen is scattered, so the brightness is further decreased.

### SUMMARY OF THE INVENTION

Therefore, the present invention has been made in view of the above problems, and it is an object of the present invention to provide a visual advertising apparatus for a gateway which can increase a brightness of a screen so that viewers can see a clear and uniform image while moving around within extended vertical and horizontal viewing angle ranges.

It is another object of the present invention to provide a visual advertising apparatus for a gateway which can enable viewers to see a clear and uniform image from a long distance.

It is yet another object of the present invention to provide a visual advertising apparatus for a gateway, of which a weight can be reduced, to thereby make it possible to install a relatively large screen to a desired position.

In accordance with the present invention, the above and other objects can be accomplished by the provision of a visual advertising apparatus for a gateway comprising: a screen which includes a reflecting surface having a reflectance of 5% to 40%, and reflecting lines formed on the reflecting surface in either a vertical or horizontal direction, the reflecting lines having a reflectance of 0.5% to 20%; and a projector for projecting light to the screen. The screen and the projector are mounted to an entrance, a gate or an escalator of a store or a building.

Preferably, the screen includes a screen base which is made from a film or a plastic material, a reflecting layer which is formed by depositing aluminum on the screen base, and a protecting surface which is formed by coating urethane or epoxy on the reflecting layer.

Preferably, the screen has a vertical viewing angle of 10° to 30° and a horizontal viewing angle of 4.5° to 20°.

Preferably, the visual advertising apparatus further comprises a mirror which is mounted in front of the projector.

Preferably, the screen is a permeable screen.

Preferably, the visual advertising apparatus further comprises a supporting frame for fixing the screen and the projector in a unitary system.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing checkout counters where a visual advertising apparatus in accordance with the present invention is mounted;.

FIG. 1a is a side view showing a vertical viewing angle range of a screen of a visual advertising apparatus in accordance with the present invention which is mounted to checkout counters;

FIG. 1b is a plan view showing a horizontal viewing angle range of a screen of a visual advertising apparatus in accordance with the present invention which is mounted to checkout counters;

FIG. 2 is a perspective view showing a visual advertising apparatus in accordance with a first preferred embodiment of the present invention;

FIG. 3 is a plan view showing a visual advertising apparatus in accordance with a first preferred embodiment of the present invention;

FIG. 4 is a side view showing formation of a vertical viewing angle of a screen of a visual advertising apparatus in accordance with the present invention;

FIG. 5 is a plan view showing formation of a horizontal viewing angle of a screen of a visual advertising apparatus in accordance with the present invention;

FIG. 6 is a perspective view showing a gate where a visual advertising apparatus in accordance with the present invention is mounted;

FIG. 7 is a side view showing an escalator where a visual advertising apparatus in accordance with the present invention is mounted;

FIG. 8 is a plan view showing a store in a shopping mall where a visual advertising apparatus in accordance with the present invention is mounted;

FIG. 9 is a front view showing an entrance where a visual advertising apparatus in accordance with the present invention is mounted;

FIG. 10 is a side view showing a visual advertising apparatus in accordance with a second preferred embodiment of the present invention, which is equipped with a mirror; and

FIG. 11 is a side view showing a visual advertising apparatus in accordance with a third preferred embodiment of the present invention, which is equipped with a permeable screen.

### DESCRIPTION OF THE PREFERRED EMBODIMENTS

Now, preferred embodiments of the present invention will be described in detail with reference to the annexed drawings.

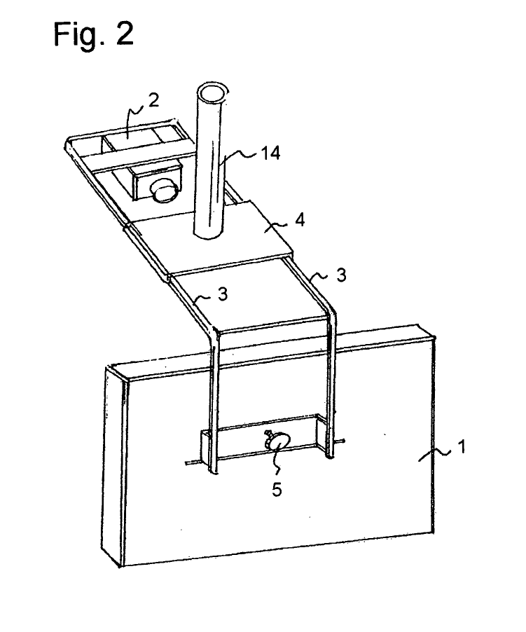

FIG. 2 is a perspective view showing a visual advertising apparatus in accordance with a first preferred embodiment of the present invention. As shown in the drawing, an angle adjuster 5 is mounted to a rear surface of a screen 1 to adjust an angle of the screen 1. A supporting frame 3 is fixed to the rear surface of the screen 1, and extends toward a front of the screen 1. A projector 2 is mounted to a front end of the supporting frame 3, spaced apart from the screen 1 by a predetermined projecting distance L. The screen 1 and the projector 2 are provided in a unitary system by the supporting frame 3.

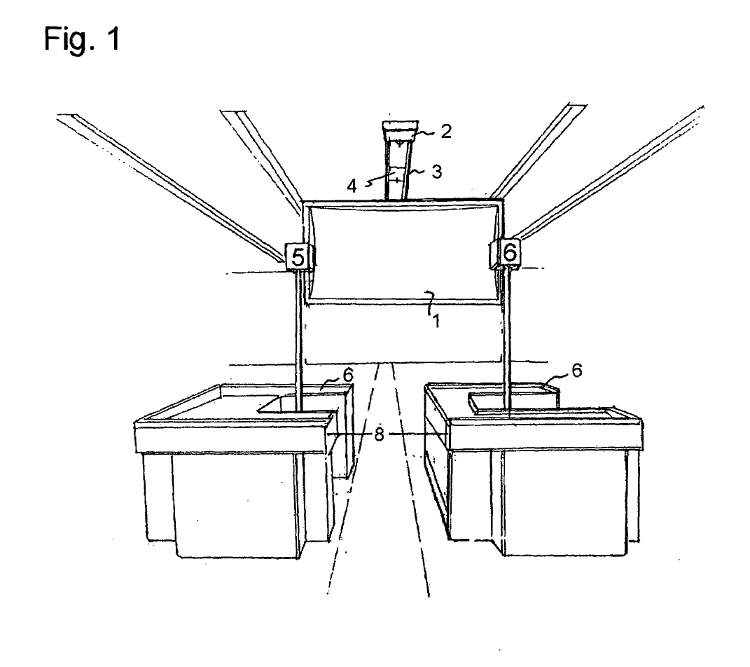

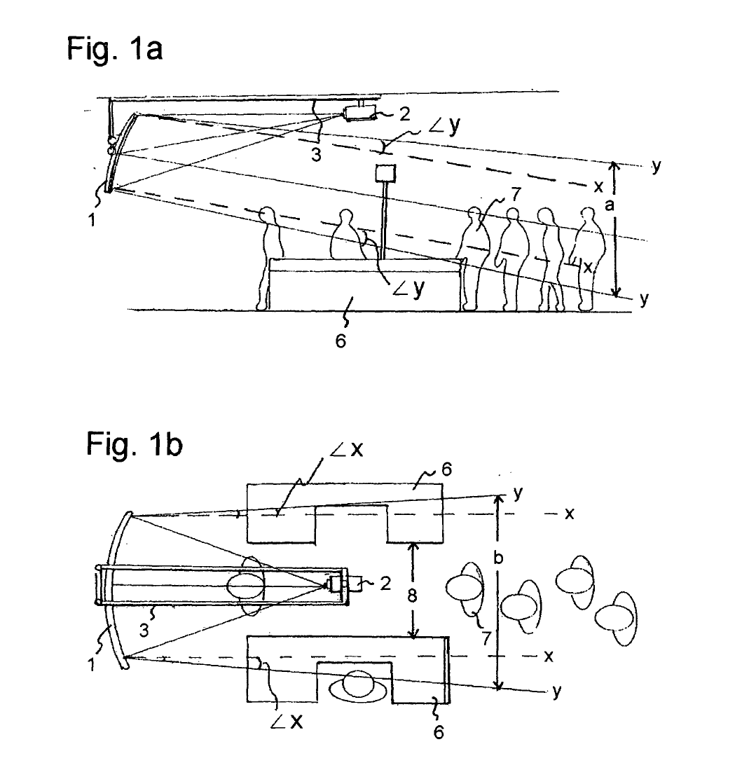

A fixing bracket 4 is formed at the supporting frame 3, at a position between the screen 1 and the protector 2, by which the screen 1 and the projector 2 are mounted to a ceiling, the checkout counters 6 (see FIG. 1) or the like.

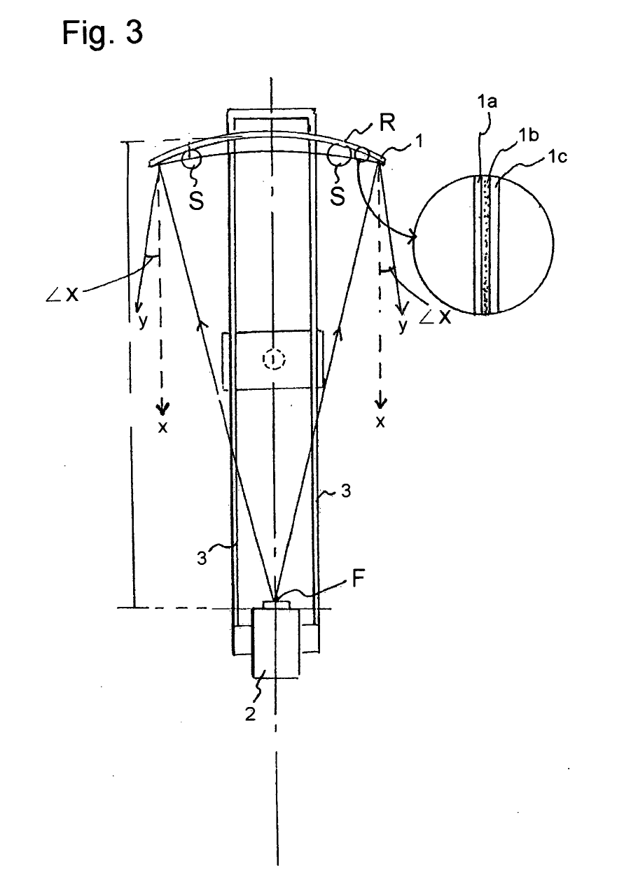

As shown in FIG. 3, the screen 1 includes a screen base 1c such as a film or plastic, a reflecting layer 1b such as an aluminum foil which is deposited on the screen base 1c, and a protecting surface 1a such as urethane or epoxy which is coated on the reflecting layer 1b. An optical diffusion material like silica may be added to the protecting surface 1a.

In the present invention, an optical constitution of the screen 1 and the projector 2 and an optical operation by a relationship between a reflectance and a scattering coefficient by a curvature R of the screen 1 and a particle size of a surface of the screen 1 are important.

The relationship between the reflectance of the screen 1 and a reflecting angle, for determining vertical and horizontal viewing angles a and b, is shown in the following the table 1.

TABLE 1

| | reflectance | | | | | | | | |
|---|---|---|---|---|---|---|---|---|---|
| | 0.5~2% | 2~3% | 5~8% | 10% | 20% | 30% | 40% | 50% | 100% |
| reflecting | 180~100° | 80~60° | 40~30° | 18~16° | 10~8° | 7~5° | 4.5~5.5° | 3~4° | 1.8~0° |
| angle | | | | | | | | | |

As seen from the table 1, the reflectance of the screen 1 is inversely proportional to the reflecting angle. For example, if the reflectance of the screen 1 is 100%, the reflecting angle is considerably small, i.e., ranging from about 1.8° to 0°. If the reflectance of the screen 1 is 1% to 2% (which is a common value of a general screen), the reflecting angle is about 180°. If the reflectance of the screen 1 is 20%, the reflecting angle is about 10° to 8°.

However, the viewing angle of the screen 1 is determined by a so-called half-value angle (which corresponds to a range of the brightness of 50% at the reference of a center of the screen 1), there may be an error in the viewing angle range according to the reflecting angle shown in the table 1.

The reflectance and the surface particle size of the screen 1 are decided by which kind of an abrasive is used for grinding the aluminum surface of the screen 1. For example, when grinding the aluminum surface with the abrasive having the grit size of 60 mesh or less, the reflectance of 1% to 2% is obtained. When grinding with the abrasive having the grit size of 3000 mesh or more, the reflectance of 90% or more is obtained.

In general, when grinding the aluminum surface of the screen 1 with the abrasive having the grit size of 180 mesh to 350 mesh, the reflectance of about 20% can be obtained. However, such a relationship between the grit size of the abrasive and the reflectance may be changed by a surface hardness, a friction velocity, a grinding method and the like.

The grinded surface of the screen 1 is protected by coating acrylic, epoxy or silicon resin thereon.

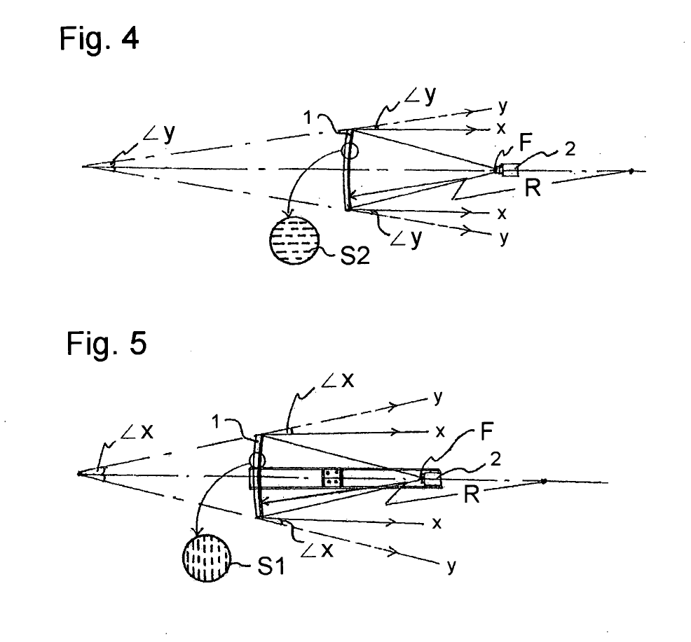

As shown in FIGS. 1a and 1b, it is preferable that the screen 1 has a width equal to or larger than a width of a passage of the installing place (e.g., the checkout counters 6), and a height high enough to be visible to as many viewers as possible who stand in line. In order to maximize the brightness of the screen 1 in terms of the effective reflecting range, as shown in FIGS. 4 and 5, the screen 1 is formed in a spherical or curved shape having a predetermined curvature R. The supporting frame 3 has a length long enough to dispose the projector 2 at a focus point F of the screen 1 having the curvature R (the distance between the screen 1 and the focus point F is defined as a projecting distance L). The reflectance of the surface of the screen 1 is set to be about 5%˜40%, however, this is not restricted thereto.

The image from the projector 2 located at the focus point F is projected to the screen 1, and reflected from the screen 1 along a reflecting line x, to remove a hot spot phenomenon.

However, if the screen 1 has only the above reflecting effect, the brightness of the screen 1 is changed when the viewer 7 sees the screen 1 at the center position and when the viewer 7 sees the screen 1 while moving around in a vertical or horizontal direction.

In other words, because the brightness of the screen 1 is different according to the viewing position of the viewer 7, the screen having only the reflecting effect is not adequate for the visual advertising apparatus mounted to the gate or the entrance.

To solve this problem, the screen 1 of the present invention includes a high-reflecting surface and a low-reflecting surface to diffuse the image within the light-collection range.

When the projector 2 is located at the focus point F of the screen 1 having the curvature R, the light projected to the both side ends of the screen 1 from the focus point F is reflected straight along the high-reflecting line x (see FIGS. 4 and 5) This optical constitution may have a problem as below.

In other words, the light of the projector 2 which is reflected straight from the screen 1 can be visible only within the range of the width or the height of the screen 1. Whenever the viewer moves, particularly, when the viewer stands at the center position of the screen 1 and when the viewer moves around, the resolution and the brightness are changed.

To solve this problem, the surface S of the screen 1 having the curvature R is formed to have the properly-combined scattering coefficient and reflectance, thereby securing the optimal vertical viewing angle a or horizontal viewing angle b.

By the curvature R of the screen 1 and the reflectance of the surface S of the screen 1, the image from the projector 2 is collected within the viewing angle range, and reflected and scattered simultaneously from the screen 1.

In order to differently adjust the vertical and horizontal viewing angle ranges by the reflectance of the surface S of the screen 1, horizontal reflecting lines S1 and vertical reflecting lines S2 are formed on the surface of the screen 1, so that vertical viewing angle a or the horizontal viewing angle b are increased or decreased.

When the reflectance of the vertical reflecting lines S2 and the horizontal reflecting lines S1 are formed to be different from each other, the vertical viewing angle a and the horizontal viewing angle b also function differently. When the reflectance of the vertical reflecting lines S2 and the horizontal reflecting lines S1 are formed to be identical to each other, the vertical viewing angle a and the horizontal viewing angle b also function identically. The horizontal reflecting lines S1 and the vertical reflecting lines S2 may be formed dualistically on the surface s of the screen 1, which will be described below.

For example, the whole surface of the screen 1 is first ground by the abrasive to have a low reflectance of about 5%, and then the horizontal reflecting lines S1 having the reflectance of about 20% are formed on the surface of the screen 1 in the horizontal direction.

On the other hand, the whole surface of the screen 1 may be first ground by the abrasive to have a high reflectance of about 20%, and then the vertical reflecting lines S2 having the reflectance of about 5% may be formed on the surface of the screen 1 in the vertical direction.

As seen from the above table 1, the vertical reflectance of 5% matches with the vertical viewing angle a of 30°, and the horizontal reflectance of 20% matches with the horizontal viewing angle b of 10° to 7°.

In other words, the whole surface S of the screen 1 is formed to have the high reflectance of about 5% to 40%, and then the horizontal reflecting lines S1 or the vertical reflecting lines S2 having the low reflectance of about 0.5% to 20% are selectively formed on the surface S of the screen 1.

On the other hand, the whole surface S of the screen may have the low reflectance, and the horizontal reflecting lines S1 or the vertical reflecting lines S2 may have the high reflectance.

The reason of forming the whole surface S of the screen 1 to have the reflectance of about 5% to 40% is as follows: because the screen 1 is generally installed to a bright place, when the reflectance is less than 5%, the image becomes obscure, and when the reflectance is more than 40%, the viewing angle becomes relatively narrow.

The reason of forming the horizontal reflecting lines S1 or the vertical reflecting lines S2 to have the reflectance of about 0.5% to 20% is as follows: when the reflectance is less than 0.5%, the reflecting effect is decreased, and when the reflectance is more than 20%, the scattering effect is decreased in comparison with the reflectance of the whole surface S of the screen 1.

Here, the “high” reflectance and the “low” reflectance are defined relatively to each other within the range of 0.5% to 40%.

For example, the reflectance of 20% is the relatively “high” reflectance, and the reflectance of 5% is the relatively “low” reflectance.

When the screen 1 has the reflectance of 20%, the light, which is projected to the screen 1, corresponding to the remaining 80% is scattered by an image pixel unit by the particle size of the surface S of the screen 1.

As such, the screen 1 performs the light-collecting and the reflecting functions as a whole, and performs the scattering function by the image pixel unit at the same time. And, because the high reflecting surface and the low reflecting surface are dualistically (vertically and horizontally) formed on the surface S of the screen 1, the viewer 7 can see the image having the uniform brightness within the light-collecting range while moving around.

The brightness of the screen 1 depends on the reflectance by the vertical viewing angle a and the horizontal viewing angle b. The total reflectance of the surface of the screen 1 is 12.5% (which is a mean value of the horizontal reflectance of 5% and the vertical reflectance of 20%).

While the total reflectance of the surface of the screen 1 is 12.5%, the light is collected and reflected at the horizontal angle of about 10° to 7° and the vertical angle of about 30°. Accordingly, the viewer 7 can see the image having the uniform brightness within the horizontal angle ranging from about 10° to 7° and the vertical angle of about 30°.

Because the screen 1 of the present invention should have a function of collecting the light (which has been scattered from the conventional screen), it is preferable to form the horizontal reflecting lines S1 (see FIG. 5) and the vertical reflecting lines S2 (see FIG. 4) to have a thickness of 0.5 μm to 300 μm in consideration of the particle size of the surface of the screen 1.

For example, when forming the thickness of the reflecting lines less than 0.5 μm by using the abrasive having the grit size of 3,000 mesh or more, the scattering and reflecting effect is considerably decreased. When forming the thickness of the reflecting lines more than 300 μm by using the abrasive having the grit size of 60 mesh or less, the surface of screen 1 becomes rough and the resolution is deteriorated.

Generally, when the surface of the screen 1 has a certain reflectance, a so-called hot-spot phenomenon in that a part of the screen is highly illuminated happens.

But, such a hot-spot phenomenon rarely happens when the reflectance of the surface of the screen 1 is in the range of 4% to 6%.

The hot-spot phenomenon generated when the reflectance of the surface of the screen 1 is more than 4% to 6% can be eliminated by forming the screen in the spherical or curved shape.

For example, when the reflectance of the vertical viewing angle a is in the range of 4% to 6% and the reflectance of the horizontal viewing angle b is in the range of 10% to 12%, the screen 1 is shaped in the vertically-curved shape. On the other hand, when the reflectance of the vertical viewing angle a is in the range of 10% to 12% and the reflectance of the horizontal viewing angle b is in the range of 4% to 6%, the screen is shaped in the horizontally-curved shape.

When the reflectance of both the vertical viewing angle a and the horizontal viewing angle b are more than 10% to 12%, the screen 1 is formed in the spherical shape.

In order to increase the brightness by the light-collection, it is important that the screen 1 has the curvature R and the focus point F corresponding to the curvature R.

The light from the projector 2 positioned at the focus point F is reflected straight from the curved or spherical surface of the screen 1 to eliminate the hot-spot phenomenon, and the viewing angle is enlarged by the reflectance of the surface of the screen 1.

In addition, the light-collecting effect and the scattering effect can be achieved organically by the reflectance of the surface of the screen 1, the scattering angle and the shape of the screen 1, thereby uniformly collecting, reflecting and scattering the light within the necessary viewing angle range and enabling the viewer to see the uniform image, from which the hot-spot phenomenon is eliminated.

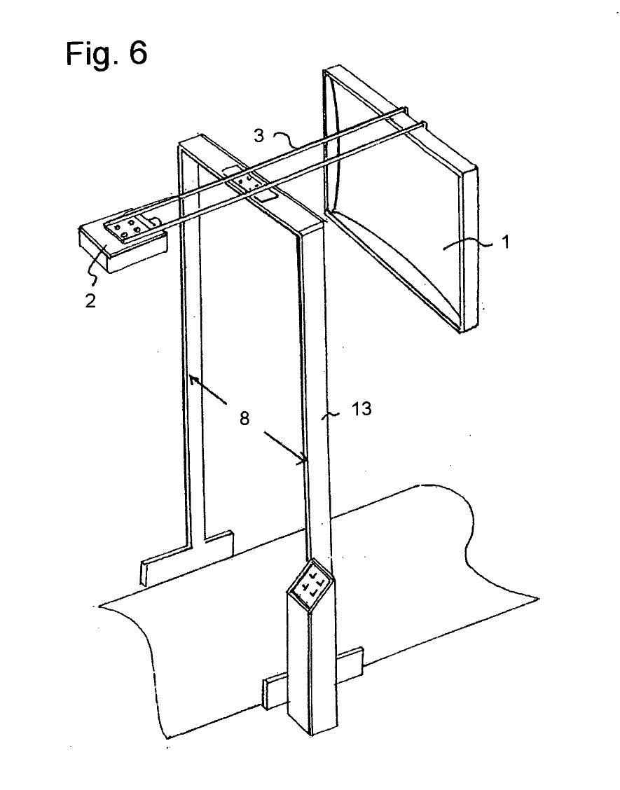

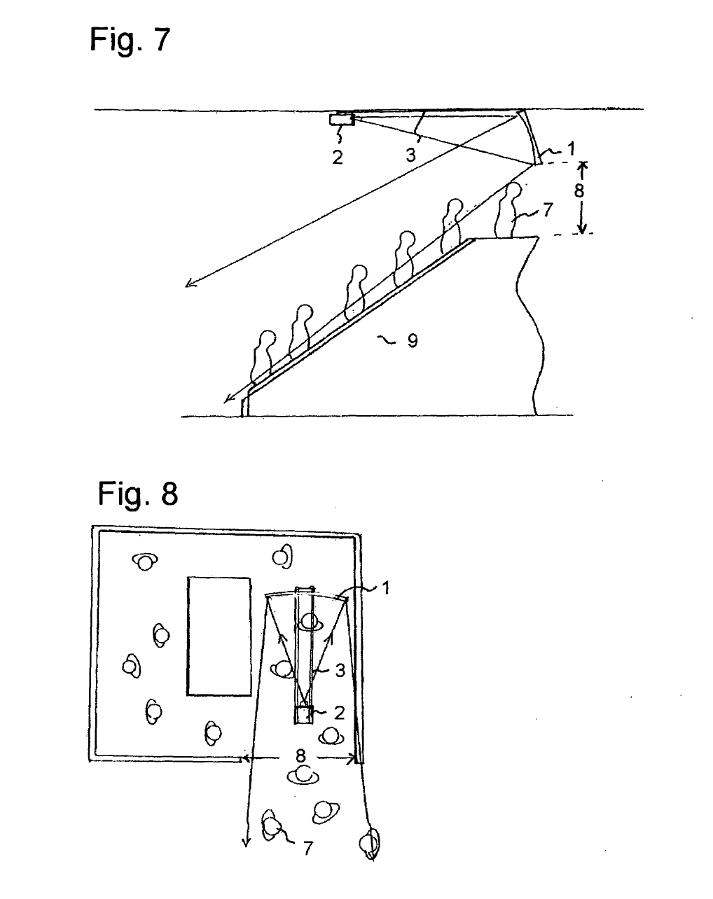

The visual advertising apparatus structured as above can be installed to the checkout counters 6 in a shopping mall, a department store or the like (see FIG. 1), to a gate 8 or a gate frame 13 (see FIG. 6), or to a boarding end portion or landing end portion of an escalator in an airport, a department store or the like (see FIG. 7).

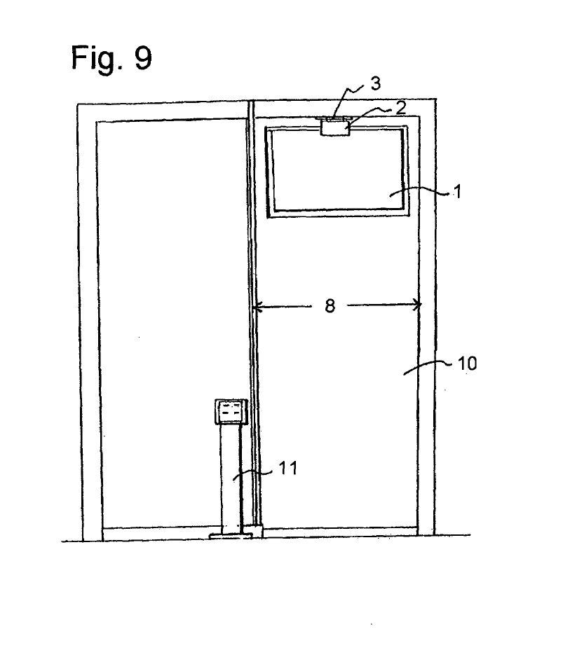

Also, the visual advertising apparatus of the present invention can be installed to an entrance of a building or an apartment (see FIG. 9), or to a ceiling in a store, in the rear of a glass door of the store, so that a customer can see the image on the screen from the outside of the store and when entering the store (see FIG. 8).

When mounting the projector 2 to the ceiling, the supporting frame 3 (see FIG. 1) is not necessarily needed, but the projector 2 should be located at the position corresponding to the focus point of the screen 1 having the curvature R.

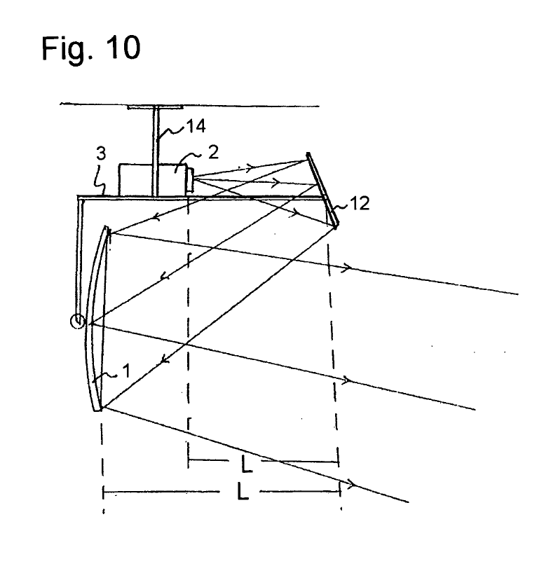

As shown in FIGS. 2 and 10, a vertical supporting rod 14 is coupled to the supporting frame 3 to adjust the installation height of the screen 1 and the projector 2.

As shown in FIG. 10, a mirror 12 may be mounted in front of the projector 2, and the screen 1 may be mounted under the projector 2.

In this case, the mirror 12 has an effect of reducing the length of the supporting frame 3 in half. The mirror 12 is located at a position such that the sum of a distance between the projector 2 and the mirror 12 and a distance between the mirror 12 and the screen 1 is same as a distance between the screen having the curvature R and its focus point.

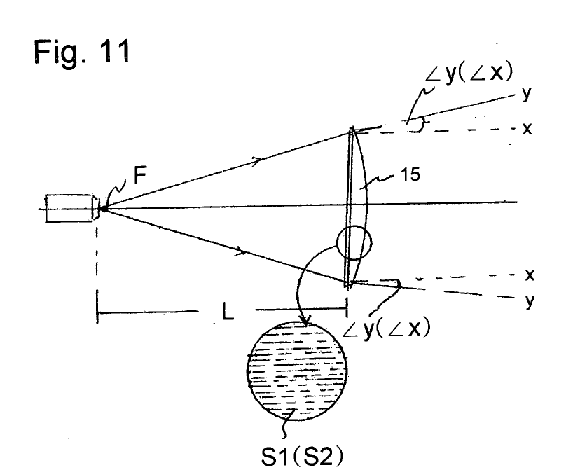

As shown in FIG. 11, a semi-transparent screen may be used as the screen 1.

The light-collecting function of the curved or spherical screen can be substituted by a permeable lens 15 such as a fresnel lens, and the scattering function can be substituted by the vertical and horizontal reflecting lines S1 and S2 by the particle size of the surface of the permeable screen.

As described above, the light projected from the projector 2 located at the focus point F of the screen 1 is reflected straight from the screen 1 along the reflecting line x, thereby eliminating the hot-spot phenomenon. And, by making the vertical reflectance and the horizontal reflectance different from each other on the screen 1, and the light is collected to the screen 1 and scattered from the screen 1 by the image pixel unit along the scattering line y (which extends with a horizontal scattering angle ∠x or a vertical scattering angle ∠y with respect to the reflecting line x). Therefore, the light-collecting, reflecting, and scattering effects are compositively achieved.

As such, since the screen 1 of the present invention collects and reflects the light, which has been diffused at 180° from the conventional screen, at the vertical angle of 10° to 30°, the brightness of the screen 1 is increased by eighteen to five times the brightness of the conventional diffusing angle of 180°. In the same manner, since the screen 1 of the present invention collects and reflects the light, which has been diffused at 180° from the conventional screen, at the horizontal angle 4.5° to 20°, the brightness of the screen 1 is increased by forty to nine times the brightness at the conventional diffusing angle of 180°. Conclusively, the present invention has an effect of increasing the brightness by five to forty times that of the prior art.

The effect of the present invention will now be described with reference to the experiment as follows:

1) size (diagonal length) of the screen 1: 80 inch (width×height=162 cm×122 cm)

2) projecting distance of the projector 2: 300 cm

3) curvature R of the screen 1: 6,000 R

4) position of the projector 2: 3,000 mm

5) brightness of the projector 2: 3,600 ANSI

6) length of the supporting frame 3 (distance between the screen 1 and the projector 2): 150 cm

7) material of the screen 1: aluminum

8) horizontal reflectance of the surface of the screen 1: 20%

9) reflectance of the vertical reflecting lines S2 of the screen 1: 5%

The screen 1 having the surface reflectance of 20% forms the horizontal viewing angle b of 8° to 10°, and the brightness of the horizontal viewing angle b is increased by eighteen times (180° (the conventional diffusing angle)/10°).

When the reflectance of the vertical viewing angle a is 5%, the diffusing angle is 30°. Therefore, the brightness of the vertical viewing angle a is increased by five times (180° (the conventional diffusing angle)/30°).

Since the vertical brightness and the horizontal brightness are combined, the average brightness is increased by about nine times.

Therefore, the viewer can see the image which is nine times as bright as the prior art within the ranges of the horizontal viewing angle b of 8° to 10° and the vertical viewing angle a of 30°.

As shown in FIGS. 4 and 5, the image projected from the projector 2 located at the focus point F is reflected straight from the screen 1 along the reflecting line x to eliminate the hot-spot phenomenon. And, the image is collected within the horizontal angle of 8° to 10° and the vertical angle of 30° along the light-collecting/scattering line y, so the viewer can see the clear and uniform image while moving around within the above angle ranges.

As a result, the viewer can see the clear image in a place which is nine times as bright as the conventional installing place.

In practice, the brightness of the screen 1 (which has a diagonal length of 80 inch) of the present invention was measured to be 3,000 cd by using a real brightness measuring device (Minolta, model no. LS-100). Here, the brightness of the test place is 1,000 Lux.

If considering that the brightness of the conventional screen (which has a diagonal length of 80 inch) is 150 cd and the brightness of the PDP (which has a diagonal length of 80 inch) is 600 cd to 800 cd, the screen 1 of the present invention is about nine times as bright as the conventional screen, and is about five times as bright as the PDP.

In the installing place of which the brightness is about 1,000 Lux, the image on the conventional screen having the brightness of 150 cd is too blurred to be seen (the brightness ratio is about 1/6 of the brightness of the installing place), the image on the PDP is a little blurred (the brightness ratio is about 1/2.5 of the brightness of the installing place), and the image on the screen 1 of the present invention is very clear due to the light-collecting/reflecting effect (the brightness ratio is about three times the brightness of the installing place).

Further, the range of the vertical viewing angle a is increased by the angle of 30° from the height (e.g., 122 cm) of the screen 1, and the range of the horizontal viewing angle b is increased by the angle of 8° from the width (e.g., 162 cm) of the screen 1. Such an increase of the vertical and horizontal viewing angles a and b results in the extension (about 2 m) of the moving distance of the viewer.

Because the screen 1 of the present invention (which has the diagonal length of 80 inch) is four times as large as the conventional screen (which has the diagonal length of 40 inch) and the light-collecting efficiency of the screen 1 of the present invention is about ten times that of the conventional screen, the image on the screen 1 of the present invention can be seen clearly from a long distance of 45 m to 50 m (the viewing distance of the conventional screen having the diagonal length of 40 inch is 10 m).

Also, a maximum effective viewing distance of the screen 1 of the present invention is 100 m (the maximum effective viewing distance of the conventional screen is 5 m, and the maximum effective viewing distance of the PDP is 15 m to 20 m).

Further, the weight of the advertising apparatus of the present invention is no more than 25 kg (the screen 1: 17 kg, the projector 2: 5 kg, the supporting frame 3: 3 kg). The weight of the advertising apparatus of the present invention is one-fourth of the weight of the PDP (the weight of the PDP of 80 inch is about 100 kg). Therefore, it is very easy and convenient to install the advertising apparatus of the present invention.

Until now, the operational effect of the screen 1 of the present invention which is nine times as bright as the conventional screen has been described. By adjusting the reflectance of the horizontal reflecting surface of the screen 1 and the vertical reflecting lines S2, the brightness of the screen 1 of the present invention can vary from five times to forty times the brightness of the conventional screen.

As apparent from the above description, the present invention provides the visual advertising apparatus for a gateway which can be formed in a unitary system by mounting the screen and the projector to the supporting frame while locating the projector at the focus point of the screen, thereby facilitating the installing process.

The screen of the present invention provides the clear image of which the brightness is about forty times that of the image on the conventional screen. Further, though the size of the screen is increased by four times the size of the conventional screen, the brightness of the screen of the present invention can be kept about ten times the brightness of the conventional screen.

When the advertising apparatus of the present invention is installed to the boarding end portion or the landing end portion of the escalator, the screen of the present invention can be formed such that the vertical viewing angle is relatively extended and the horizontal viewing angle is relatively reduced by increasing the reflectance of the surface of the screen to extend the vertical viewing angle more than the horizontal viewing angle. Therefore, all passengers on steps of the escalator can see the clear image on the screen.

Also, the advertising apparatus of the present invention can be easily mounted in a store, an office, a restaurant, a department store or the like. Especially, when the advertising apparatus is installed in the rear of the glass door of the store, the apparatus causes many people to enter the store. Also, when the advertising apparatus is installed in the front of the gate of the department store, the apparatus has an effect of inducing many people to enter the department store, to thereby increase the sales.

Further, when the advertising apparatus is installed in the place having a high or complex ceiling structure, the apparatus can be easily installed by coupling the vertical supporting rod to the supporting frame.

Conclusively, the present invention has advantages that the brightness of the screen is increased by five to forty times, the viewers can see the clear image while moving around within the extended vertical and horizontal viewing angles of 30° to 4.5°, and the weight of the screen and the projector can be reduced, which makes it possible to install the large screen having the size of 60 inch to 120 inch.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A visual advertising apparatus for a gateway comprising:
a screen which includes a reflecting surface having a reflectance of 5% to 40%, and reflecting lines formed on the reflecting surface in either a vertical or horizontal direction, the reflecting lines having a reflectance of 0.5% to 20%; and
a projector for projecting light to the screen,
wherein the screen and the projector are mounted to an entrance, a gate or an escalator of a store or a building.

2. The apparatus according to claim 1, wherein the screen includes a screen base which is made from a film or a plastic material, a reflecting layer which is formed by depositing aluminum on the screen base, and a protecting surface which is formed by coating urethane or epoxy on the reflecting layer.

3. The apparatus according to claim 1, wherein the screen has a vertical viewing angle of 10° to 30° and a horizontal viewing angle of 4.5° to 20°.

4. The apparatus according to claim 11 further comprising:
a mirror which is mounted in front of the projector.

5. The apparatus according to claim 1, wherein the screen is a permeable screen.

6. The apparatus according to claim 1, further comprising:
a supporting frame for fixing the screen and the projector in a unitary system.
